(19) United States
(12) Patent Application Publication
(10) Pub. No.: US 2024/0208036 A1
(43) Pub. Date: Jun. 27, 2024

(54) Height Adjustable Workstation

(71) Applicant: John Stephen Lanphear, Lawrence, MI (US)

(72) Inventor: John Stephen Lanphear, Lawrence, MI (US)

(21) Appl. No.: 18/392,960

(22) Filed: Dec. 21, 2023

Related U.S. Application Data
(60) Provisional application No. 63/434,319, filed on Dec. 21, 2022.

(51) Int. Cl. B25H 1/16

(52) U.S. Cl. CPC B25H 1/16

(57) ABSTRACT

A height adjustable table or workstation incorporates a conveyor section, preferably powered, that also tilts down to allow easier loading of boxes placed on a conveyor surface. The operator has switches, either operated by hand or foot or both, that control the table tilting (both down and up), and the conveyor surface. With this new ergonomic worktable, the operator builds a box on the conveyor surface, and then touches a button with their hand or foot to tilt the conveyor surface down. The operator then easily loads items into the box, and then touch a button to raise the conveyor surface back up to horizontal. The operator then could touch a button to start the conveyor surface that would quickly move the loaded box, off the conveyor surface and onto another surface such as a transfer conveyor.

### CROSS REFERENCE TO RELATED APPLICATIONS

This application claims the benefit of U.S. Provisional Patent 63/434,319 filed Dec. 21, 2022, entitled “Ergonomic Lift, Tilt, and Conveyor Belt”, which is incorporated herein by reference.

### FIELD OF THE INVENTION

This application is directed to the field of height adjustable workstations.

### BACKGROUND OF THE INVENTION

Package distribution centers process numerous packages daily. Each package has to be filled and then sorted and sent to a final destination. The distribution centers are typically provided with pack out lines where the packages are filled. The pack out lines are often simply provided with racks that hold flattened or folded boxes, fixed height worktables and a power conveyor arranged perpendicular to the worktables. Each operator works at a worktable that has a slippery tabletop designed to allow boxes to slide across the tabletop.

In operation, an operator takes a flatten box from the rack and assembles the box on the table. The operator then places items into the assembled box. Since the tables are fixed height placing items into the box is not easy. Indeed, the difficulty of loading the boxes depends on the size and height of the box and the size and weight of the items placed in the box and can become quite difficult. Once the box is full, the operator then would have to push the loaded box across the tabletop and onto the main powered roller conveyor.

Operators try to process the items and boxes as quickly as possible. Therefore, there exists a need in the art for a system to assist operators in this task.

### SUMMARY OF THE INVENTION

The subject invention is directed to a height-adjustable workstation including a base frame and a sliding support assembly. The sliding support assembly includes a slider frame slidably mounted on the base frame and an upper support surface pivotably mounted to the slider frame. A lifting mechanism is located between the base frame and the slider frame. The lifting mechanism is configured to move the slider frame relative to said base frame between a lower position and an upper position. A tilting mechanism is located between the slider frame and the upper support surface. The tilting mechanism is configured to tilt the upper support surface between horizontal dispensing position down to a tilted loading position. The upper support surface includes an upper side and a lower side. The tilting mechanism includes an actuator that extends from the sliding frame to the lower side of the support surface.

The height-adjustable workstation also includes a control panel with a first control button or switch for actuating the lift mechanism and a second control button or switch for actuating the tilting mechanism. Preferably the upper support surface is part of a conveyor, and the conveyor is a belt mounted on two pulleys and driven by a motor. Preferably the control panel includes a third control button or switch for actuating the support surface conveyor. A fourth selector switch allows the operator to put the controller into automatic mode so the operator can simply actuate the third control button or switch to automatically actuate the tilting mechanism to level the support surface conveyor and also then automatically actuate the support surface conveyor.

The height-adjustable workstation also includes a transfer conveyor located at one end of the support surface. Preferably the transfer conveyor has powered rollers. Also, when the support surface conveyor is in the lower position packages can be easily moved onto the transfer conveyor. The support surface conveyor can also be actuated while the height-adjustable workstation is in the raised position, and the support surface conveyor will easily move the packages onto the transfer conveyor, but the boxes may tip over. An additional transfer chute can be attached to the end of the support surface conveyor that would vary in angle depending on the height the support surface conveyor is raised, but this would help reduce the likelihood of the boxes tipping over when moved to the transfer conveyor.

In use an operator places the upper support surface at the upper level and then assembles a box on the upper support surface. The operator then tilts the support surface with the tilting mechanism and loads the box. Next the operator tilts the support surface up to a horizontal transferring position by actuating a second control button or switch and then actuates the top surface conveyor by actuating a third control button or switch to move the box onto a transfer conveyor.

Additional objects, features and advantages of the invention will become more readily apparent from the following detailed description of preferred embodiments of the invention when taken in conjunction with the drawings wherein like reference numerals refer to corresponding parts in the different views.

### BRIEF DESCRIPTION OF THE DRAWINGS

FIG. 1 is a perspective view of a height-adjustable workstation with a support surface and a transfer conveyor, constructed in accordance with the present invention, with the support surface at a lower height and level.

FIG. 2 is a perspective view of the height-adjustable workstation and the transfer conveyor of FIG. 1 with the support surface at the lower height and tilted.

FIG. 3 is a perspective view of the height-adjustable workstation and the transfer conveyor of FIG. 1 with the support surface at a raised height and tilted.

FIG. 4 is a perspective view of the height-adjustable workstation and the transfer conveyor of FIG. 1 with the support surface in the raised height and level.

### DETAILED DESCRIPTION OF THE INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show particular details. Therefore, specific structural and functional details disclosed herein are not to be interpreted as limiting, but merely as a representative basis for teaching one skilled in the art to employ the present invention.

As used in this specification and the appended claims, the singular forms “a”, “an” and “the” include plural referents unless the content clearly dictates otherwise. As used in this specification and the appended claims, the term “or” is generally employed in its sense including “and/or” unless the content clearly dictates otherwise.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “front,” “back,” “top” and “bottom”, as well as derivatives thereof (e.g., “horizontally,” “downwardly,” “upwardly,” etc.), should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

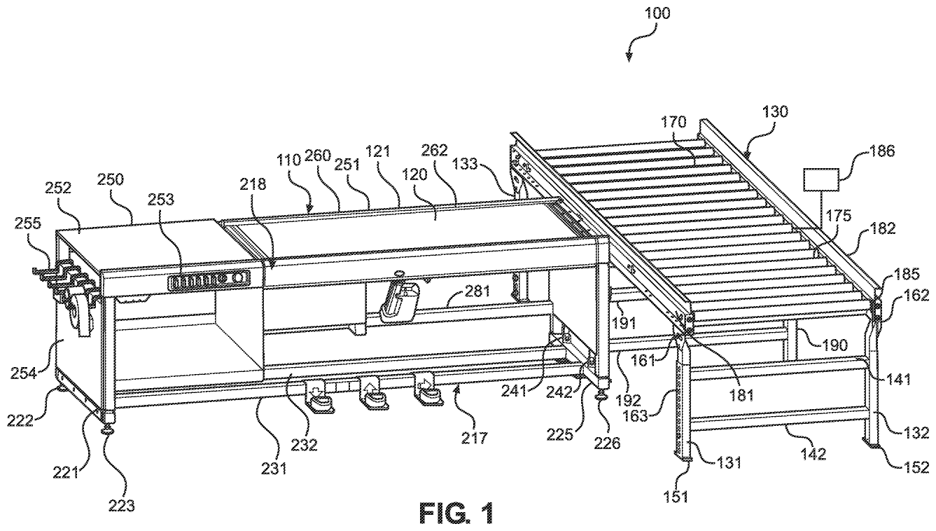

With initial reference to FIG. 1, there is illustrated a loading system 100. The loading system 100 includes a height adjustable workstation 110 with an upper support surface 120 is part of a top surface conveyor 121 and a roller conveyor 130, constructed in accordance with the present invention.

The roller conveyor 130 includes four upstanding corner legs, of which three are shown and labeled 131-133. Two of the corner legs 131, 132 are connected by an upper cross beam 141 and lower cross beam 142. The corner legs 131, 132 are provided with feet 151, 152 at their bottom end and connecting flanges 161,162 at their top end so that the roller conveyor 130 can be supported on a flat surface such as a floor in the distribution center. One of the corner legs 131 is shown with mounting holes 163 which are used to mount the upper cross beam 141 and the lower cross beam 142 at a desired height. The other legs also preferably have such holes, but they are not separately shown. The other two corner legs are constructed in the same manner and will not be separately described.

The roller conveyor 130 also includes a top surface 170 formed of a series of rollers 175 that extend between a first support rail 181 and a second support rail 182. The rollers 175 are mounted on bearings, such as bearing 185 mounted on second support rail 182, that allow the rollers 175 to freely rotate. Alternatively, the rollers may be powered by actuators 186. The first support rail 181 is mounted to connecting flange 161 at one end and to connecting flange 187 at another end. In similar manner the second support rail 182 is also supported by legs. The second support rail 182 is also preferable supported by a middle leg 190 which is connected to an upper cross beam 191 and a lower cross beam 192.

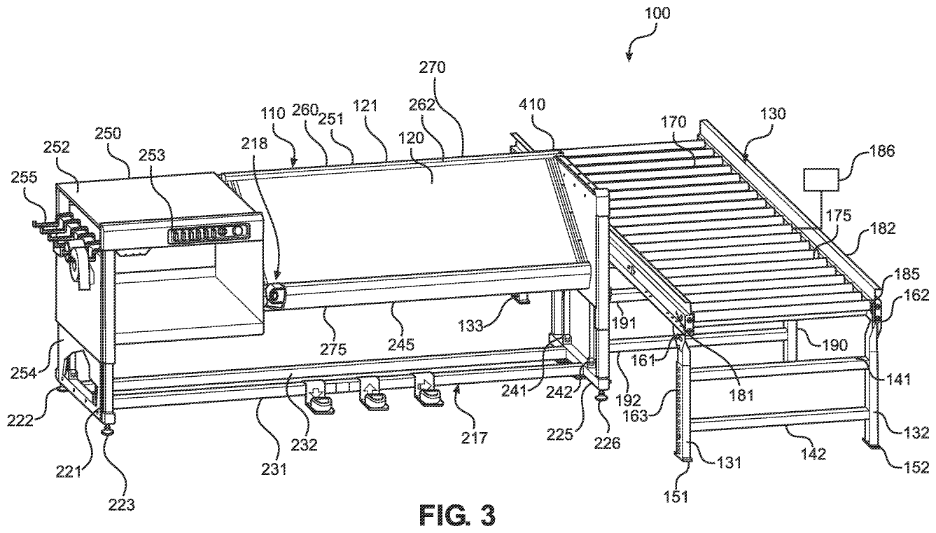

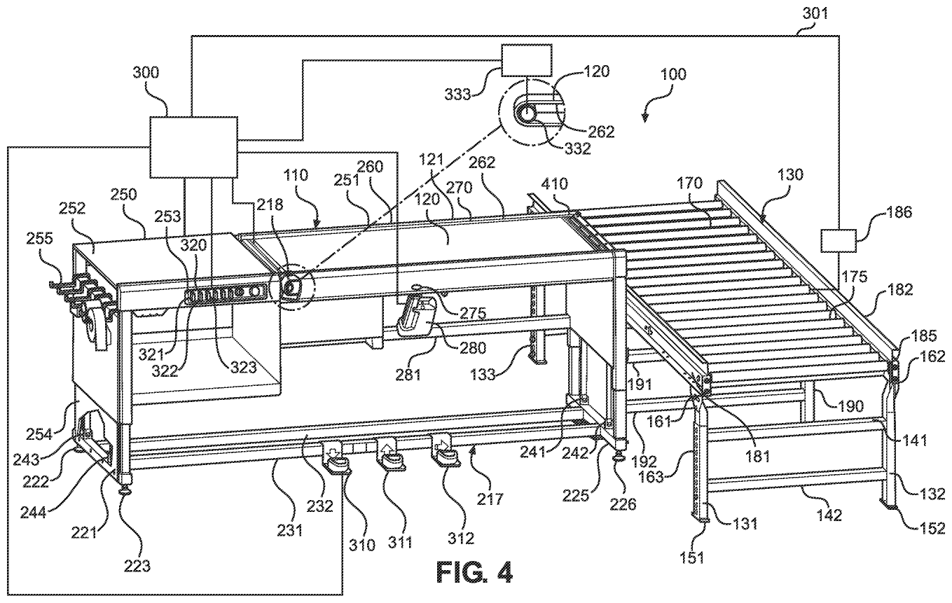

The height adjustable workstation 110 is provided with a base frame 217 and a sliding support assembly including a slider frame 218. The base frame 217 has a first end beam 221 supported by two feet 222, 223 and a second end beam 225 also has two feet only one of which is shown at 226. The base frame 217 also has a front support beam 231 extending between the first end beam 221 and the second end beam 225 and a rear support beam 232 also extending between the first end beam 221 and the second end beam 225. The slider frame 218 is supported by a group of lifting mechanisms in the form of supporting actuators 241, 242, 243, 244, best seen in FIGS. 3 and 4, which are provided between the base frame 217 and the slider frame 218. Preferably, as shown, the supporting actuators 241, 242, 243, 244 are a set of electric motors. The motors may be the LA31 series of motors produced by Linak Corporation as shown. The actuators preferably use screw drives, although other types of linear actuators or motors can also be used (e.g., hydraulic, pneumatic). Typically, such motors are available in four different load capacities which are 1,500 newtons, 2,000 newtons, 4,000 newtons and 6,000 newtons. Ideally the load capacity would be matched with a final users' desires depending on what type of load or usage the loading system 100 will be used for. More details regarding a vertically adjustable table are found in U.S. Pat. No. 6,874,432 incorporated herein by reference.

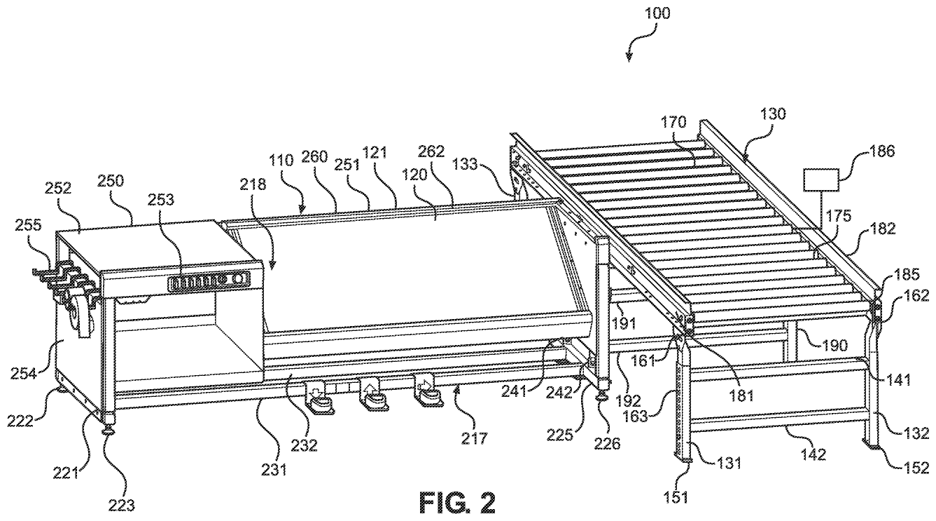

The slider frame 218 has a level section 250 and a tilting mechanism 251. The level section 250 includes a level top 252 with a control panel 253. The level section 250 also includes a side panel 254 and a set of storage hooks 255. The tilting mechanism 251 has an upper support surface 120 which is part of a top surface conveyor 260 including a belt section 262. The tilting mechanism 251 is configured to tilt the upper support surface 120 between a horizontal dispensing position shown in FIGS. 1 and 4 down to a tilted loading position shown in FIGS. 2 and 3. As best seen in FIG. 3, the upper support surface 120 includes an upper back side 270 and a lower front side 275. The tilting mechanism 251 includes a tilting mechanism actuator 280 that extends from a back beam 281 to the lower front side 275 of the upper support surface 120.

The height adjustable workstation 110 also includes a controller 300 with control lines 301. The control lines 301 extend to the actuators 241-244 that raise and lower the height-adjustable workstation 110 and to various foot controls 310, 311, 312 and a control panel 320. The control panel 320 includes several buttons, with a first control button 321 or switch for actuating the lift mechanisms 241-244 and a second control button 322 or switch for actuating the tilting mechanism actuator 280. Preferably the upper support surface 120 is part of top surface conveyor 121 and the top surface conveyor 121 includes a belt 331 mounted on two pulleys only one shown at 332 and driven by a motor 333. Preferably the control panel 320 includes a third control button 323 or switch for actuating the top surface conveyor 121. Preferably the control panel 320 includes a fourth selector switch 324 that provides an option for the operator to select between manual controls, that operates as previously described, or an automatic mode. When automatic mode is selected using switch 324, the controller 300 allows the for the operator to control button 323 or switch that automatically actuates the tilting mechanism 251 to level the top surface conveyor 121 and also then actuates the top surface conveyor 121 to move boxes so as to free the operator up to perform other tasks while this process completes.

In use an operator places the upper support surface 120 at the upper level and then assembles a box on the upper support surface 120. The operator then tilts the support surface 120 down with the tilting mechanism by actuating the second control button and loads the box. Next the operator tilts the support surface 120 back up to a horizontal transferring position by actuating the second control button 321 or switch and then actuates the top surface conveyor 121 by actuating the third control button 323 to move the box onto the roller conveyor 130.

In any case, although described with reference to exemplary embodiments of the invention, it should still be understood that modifications can be made to the invention as disclosed without departing from the spirit of the invention.

What is claimed is:

1. A height adjustable workstation comprising:
a base frame;
a sliding support assembly including a slider frame slidably mounted on the base frame and an upper support surface pivotably mounted to the slider frame;
a lifting mechanism located between the base frame and the slider frame, said lifting mechanism configured to move said slider frame relative to said base frame between a lower position to an upper position; and
a tilting mechanism located between the slider frame and the upper support surface, said tilting mechanism configured to tilt the upper support surface between horizontal dispensing position down to a tilted loading position.

2. The height adjustable workstation of claim 1, wherein the upper support surface includes an upper side and a lower side, and the tilting mechanism includes an actuator that extends from the slider frame to the lower side of the upper support surface.

3. The height adjustable workstation of claim 1, further comprising a control panel with a first control button or switch for actuating the lifting mechanism and a second control button or switch for actuating the tilting mechanism.

4. The height adjustable workstation of claim 1, wherein the upper support surface is part of an upper support surface conveyor.

5. The height adjustable workstation of claim 4, wherein the upper support surface conveyor is a belt mounted on two pulleys and driven by a motor.

6. The height adjustable workstation of claim 4, further comprising a control panel with a first control button or switch for actuating the lifting mechanism, a second control button or switch for actuating the tilting mechanism, and a third control button or switch for actuating the upper support surface conveyor.

7. The height adjustable workstation of claim 6, wherein the third control button or switch actuates the tilting mechanism to level the upper support surface conveyor and also then actuates the upper support surface conveyor automatically when a fourth selector switch is put into automatic mode.

8. The height adjustable workstation of claim 6, further comprising a transfer conveyor located at one end of the upper support surface.

9. The height adjustable workstation of claim 8, wherein the transfer conveyor has powered rollers.

10. The height adjustable workstation of claim 8, wherein the height-adjustable workstation interfaces with the transfer conveyor in such a way so as to move the box onto the transfer conveyor when there is room for the box between other boxes coming down the transfer conveyor.

11. The height adjustable workstation of claim 9, wherein the upper support surface conveyor in the lower position is configured to move packages onto the transfer conveyor.

12. A height-adjustable workstation comprising:
a base frame;
a sliding support assembly including a slider frame slidably mounted on the base frame and an upper support surface which is part of an upper support surface conveyor pivotably mounted to the slider frame;
a tilting mechanism located between the slider frame and the upper support surface, said tilting mechanism configured to tilt the upper support surface between a loading position and a transfer position; and
a control panel with a first control button or switch for actuating the lifting mechanism, a second control button or switch for actuating the tilting mechanism, and a third control button or switch for actuating the upper support surface conveyor.

13. The height-adjustable workstation of claim 12, wherein the second control button or switch actuates the tilting mechanism to level the upper support surface conveyor and also then actuates the upper support surface conveyor.

14. A method of operating a height-adjustable workstation including a base frame, a sliding support assembly including a slider frame slidably mounted on the base frame and an upper support surface pivotably mounted to the slider frame, said method comprising:
assembling a box on the upper support surface;
tilting the upper support surface with a tilting mechanism located between the slider frame and the upper support surface, by tilting the upper support surface between horizontal dispensing position down to a tilted loading position; and
loading the box.

15. The method of claim 14, further comprising lifting the box with a lifting mechanism located between the base frame and the slider frame, by moving said slider frame relative to said base frame between a lower position to an upper position.

16. The method of claim 14, further comprising tilting the upper support surface up to a horizontal transferring position by actuating a first control button or switch.

17. The method of claim 15, wherein the upper support surface includes a top surface conveyor and further comprising actuating the top surface conveyor to move the box onto a transfer conveyor.

18. The method of claim 17, further comprising tilting the upper support surface up to a horizontal transferring position and actuating the top surface conveyor to move the box onto a transfer conveyor by actuating a first control button or switch.

19. The height adjustable workstation of claim 9, wherein the upper support surface conveyor in the any position is configured to move packages onto the transfer conveyor.

20. The height adjustable workstation of claim 9, wherein the upper support surface conveyor in the any position is configured to move packages onto the transfer conveyor using a pivoting transfer chute that moves with the height adjustable workstation and maintains a height on the fixed height transfer conveyor.

21. The height adjustable workstation of claim 9, further comprising a transfer conveyor located at the back end of the upper support surface parallel to the height adjustable workstation, and the support surface conveyor on the height adjustable workstation moves the box away from the operator to the rear transfer conveyor.

22. The height adjustable workstation of claim 4, further comprising a control panel with a first control button or switch for actuating the lifting mechanism, and a second control button or switch for actuating the upper support surface conveyor.

23. The height adjustable workstation of claim 22, wherein the second control button or switch actuates the upper support surface conveyor automatically when a fourth selector switch is put into automatic mode.

24. The height adjustable workstation of claim 22, further comprising a transfer conveyor located at one end of the upper support surface.

25. The height adjustable workstation of claim 22, further comprising a transfer conveyor located at the back end of the upper support surface parallel to the height adjustable workstation, and the support surface conveyor moves the box away from the operator to the rear transfer conveyor.

26. The height adjustable workstation of claim 6, further comprising a transfer conveyor located at one end of the upper support surface and oriented perpendicular to the upper support surface.
